(19) United States
(12) Patent Application Publication
(10) Pub. No.: US 2017/0328085 A1
(43) Pub. Date: Nov. 16, 2017

(54) REACTIVE BUMPING-RESISTANCE DEVICE THAT CAN BE IMPLEMENTED IN A LOCK POSSIBLY AS A RETROFIT WITHOUT ALTERATIONS TO THE BODY OR ROTOR OF THE SAME

(71) Applicant: VIRO S.p.A., Zola Predosa (Bologna) (IT)

(72) Inventor: Filippo BASTIANINI, Bologna (IT)

(21) Appl. No.: 15/527,488

(22) PCT Filed: Nov. 27, 2015
(86) PCT No.: PCT/IT2015/000289

§ 371 Date: May 17, 2017

(30) Foreign Application Priority Data
Dec. 10, 2014 (IT) BO2014A000693
Dec. 10, 2014 (IT) BO2014A000694

(51) Int. Cl. E05B 27/00; E05B 9/04; E05B 45/06

(52) U.S. Cl. CPC E05B 27/0071; E05B 27/0021; E05B 9/04; E05B 45/06

(57) ABSTRACT

An Apparatus that can be implemented in a conventional pin/tumbler (piston/counter-piston) cylinder lock type without substantial alterations of the hull (body) and/or of the plug (rotor) of the same lock and capable of making the lock resistant in a non-passive way to the lock picking technique called “bumping” by means of a reaction in which the “bumping” mechanical pulse that is (at least partially) received by a first section with greater length of a sectioned counter-piston, is eccentrically transmitted to a pivoting element creating a mechanical torque that converts it at least partially in a reaction pulse applied to a second section of the fractioned counter-piston along a direction that drives the said second section to engage the lock position between the body and the rotor.

### TECHNICAL FIELD OF THE INVENTION

The present invention concerns a pin/tumbler (piston/counter-piston) cylinder lock designed to be resistant to the lock picking technique known as “bumping”. The present invention in particular discloses an apparatus that can be implemented in a conventional pin/tumbler lock type without substantial alterations of the hull (body) and/or of the plug (rotor) of the same lock, with the scope of making the lock resistant in a non-passive way to the lock picking technique called “bumping” by means of a reaction mechanism in which the “bumping” mechanical pulse is (at least partially) received by a first longer section of a longitudinally fractioned driver pin (counter-piston) and is eccentrically transmitted to a pivoting element that converts the received action, at least partially, in a reaction pulse that is applied to a second section of the fractioned driver pin (counter-piston) along a direction that drives the said second section to engage the shear line between the hull (body) and the plug (rotor) of the lock.

### BACKGROUND OF THE INVENTION

The name “bumping” identifies (i.e. from the document U.S. Pat. No. 1,667,223) a lock picking technique working on standard key pin/driver pin (piston/counter-piston) mechanisms due to the inertial reaction to a momentum applied to the lock pins. The said “bumping” is performed using a “bumping” key having a blade profile matching the slit profile of the lock but with slightly shortened blade and shoulder (i.e. filed 0.2 mm on the blade tip and shoulder) and all the key cuts at the maximum depth so that when the key blade is inserted in the lock plug, all key pins are driven to touch the key cuts staying completely inside the shape of the lock plug. The picking is obtained by continuously applying a small torque and tapping the head of the key while its blade is fully inserted in the lock. In this configuration all key pins individually receive a tap momentum when touched by the sides of the key cuts and such momentum is partially transferred to the respective driver pins along the direction of their axes. Due to the inertia, the key pins do not move and stay inside the shape of the lock plug, while the driver pins move away from them working against the springs, momentarily dislocating themselves completely outside the shape of plug, thus clearing the shear line engagement and allowing the torque applied to the key head to rotate the plug and open the lock.

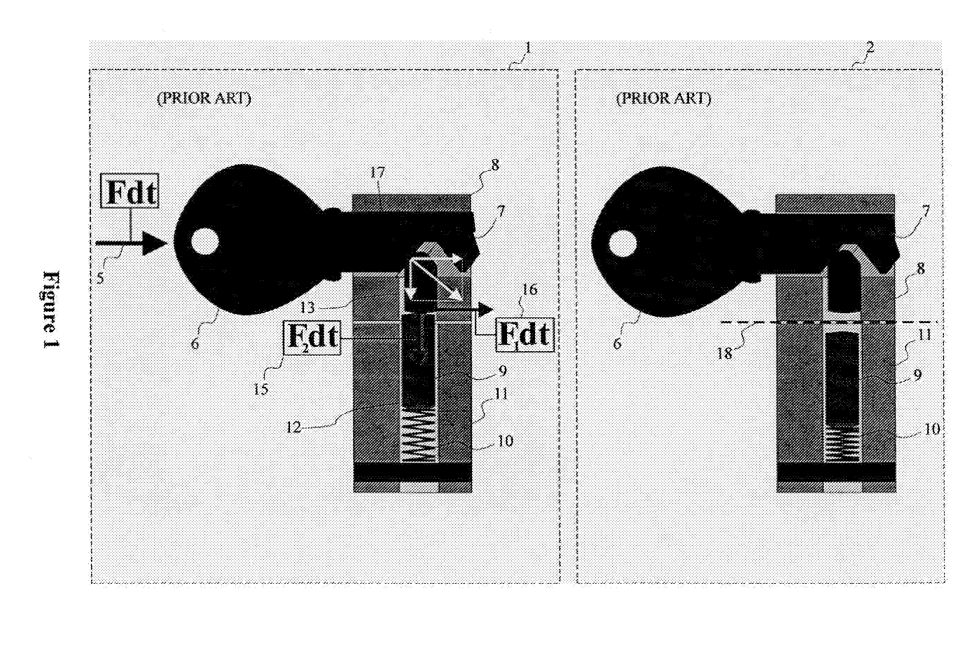

FIG. 1 illustrates the “bumping” effect on a schematic section of pin/tumbler cylinder lock. In the frame (1) it is shown the initial configuration of the lock in which a force F is applied to the head of the “bumping” key for a time dt generating a momentum (5) of intensity Fdt that is transmitted to the key pin (7) thought the contact plane (17) between the side of the key cut and the head of the key pin. The said momentum is vectorially decomposed in a first (axial) component F1dt aligned to the axis of the lock plug and in a second (radial) component F2dt aligned to the axis of the pins (7,9). The component F1dt unloads on the plug (8) while the radial component F2dt is transferred to the driver pin (9) and works against the action of the spring (10) moving the driver pin (9) away from the position in touch with the key pin (7) that is driving the system to achieve the configuration that is illustrated in the frame (2). The frame (2) shows the momentary configuration of the lock that is obtained by application of the momentum Fdt, in which the position of the driver pin (9) is totally inside the shape of the lock hull (12) while the key pin (7) stays completely inside the shape of the lock plug, so that both pins momentarily disengage the shear line (18) between the plug (8) and hull (11) and plug rotation is allowed thus opening the lock.

### PRIOR ART

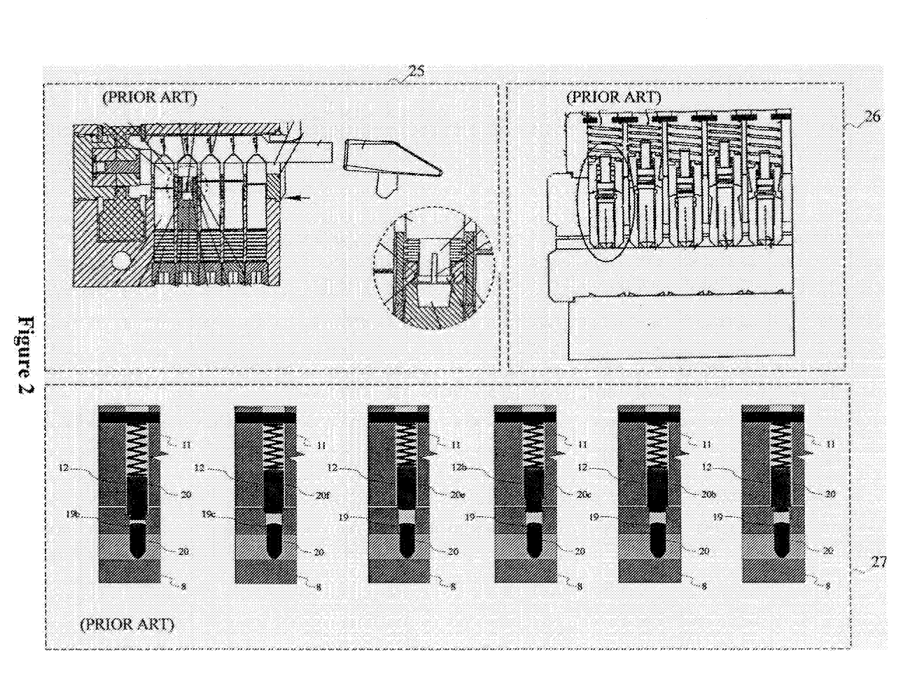

Are known some embodiments of pin/tumbler locks having increased resistance to the “bumping” type lock picking. The document US2005/0204788A1 discloses a lock characterized by coaxial pins according to the schematic representation in the frame (26) of FIG. 2, in which the key pin/driver pin mechanism is obtained by separate coaxial key pins/driver pins. Such embodiment is however expensive to make and difficult to implement as a retrofit in a conventional pin/tumbler lock without important alterations. The documents U.S. Pat. No. 8,302,439B1, U.S. Pat. No. 7,963,135B1, U.S. Pat. No. 7,775,074B1 disclose “bumping” resistant locks characterized by rotating pins that are again expensive to make and difficult to implement as a retrofit in a conventional pin/tumbler lock without important alterations.

The document RU2462572C1 discloses a “bumping” resistant lock characterized by a multiplicity of coaxial rotors and chain-type mechanisms comprising balls and pins. This said solution cannot be implemented as a retrofit in a conventional pin/tumbler lock without important alterations.

The document US2005022568A1 discloses a pin/tumbler lock as schematically shown in the frame (25) of FIG. 2, in which the key pin is characterized by a “harpoon-like” end and the driver pin by a conic receptacle facing such end, so that, under the impulse action of a “bumping” attempt, the key pin can couple in a metastable way to the driver pin while a spring-driven coupling lockout mechanism prevents the coupling during the normal operations. In case of “bumping” the key pin hooks the driver pin so that they are forced to move together and cannot clear the shear line between plug and hull at the same time it is cleared by the other conventional key-pin/driver pin pairs, thus preventing the effectiveness of the “bumping” attempt.

This solution, due to the complexity of the harpoon shape, is expensive to make and requires pins of increased diameter, for this reason it cannot be implemented as a retrofit in a conventional pin/tumbler lock without important alterations.

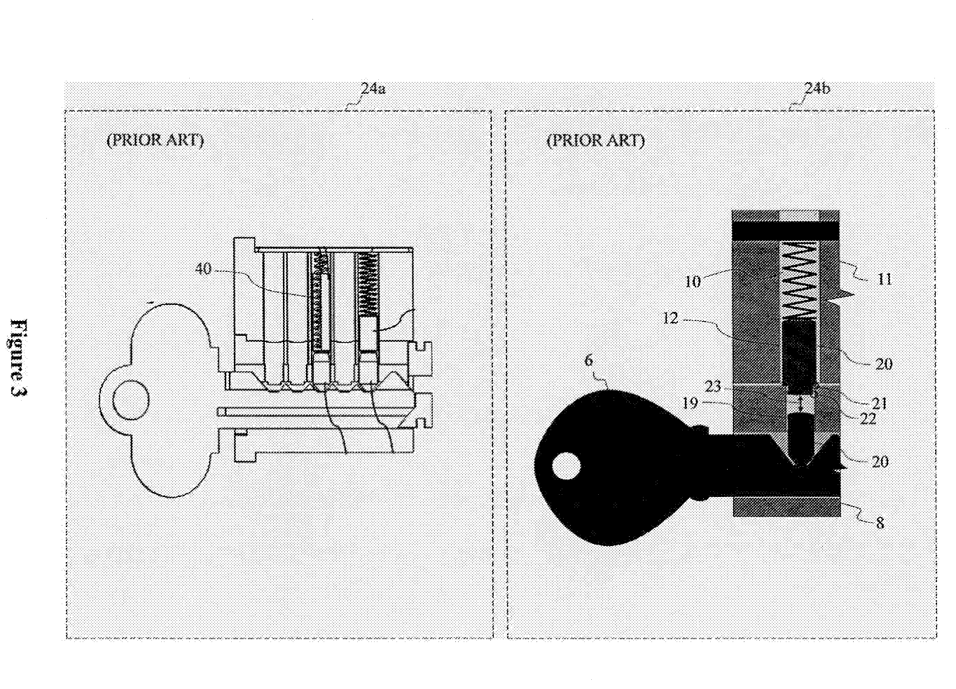

The documents US2008202181A1 and US2012180537A1 disclose a “bumping” resistant pin/tumbler lock according to the schematic shown in the frame (24b) of FIG. 3, in which the end of one of the driver pins (20) is dove-tail shaped so that to grip across the shear line dividing the pin housing hole in the plug (19) from that in the hull (12). Such solution, that is also described in a wide range of alternative embodiments as from the frame (27) of FIG. 2, is characterized by the need of different diameters for the pin housing hole in the plug (19) and in the hull (12) and therefore it cannot be implemented as a retrofit in a conventional pin/tumbler lock without important alterations.

The document US2011214462A1 discloses a pin/tumbler lock, as schematically shown in the frame (24a) of FIG. 2, in which one of the driver pins is a pipe (40) offering, in case of “bumping” a different inertia and stop point in comparison to those of the other conventional driver pins. Although this solution could be, in line of principle, implemented as a retrofit without requiring important alterations, its effectiveness is limited to a “bumping” momentum of small intensity and within a limited range of the impulse repetition frequency as has to be considered not fully satisfying in general.

The document WO2007074163A1 discloses a “bumping” resistant pin/tumbler lock in which one of the driver pins is substituted by a pair of elements having different length so that, when the respective key pin couples to a key cut at the maximum depth, it keeps the mechanical contact only with the longer of the two facing driver pin elements that results compressed between the spring and the key pin, while between the key pin and the shorter driver pin elements remains a gap between due to the gravity force that drags the shorter elements towards the spring, when the lock is installed with the spring on he bottom side. Due to the gap, the “bumping” momentum is collected by the longer driver pin element only, so that if the length of the shorter one is chosen to keep the engagement of the shear line, the shorter element keeps the engagement of the lock and prevents the effectiveness of the “bumping” action. Although this solution can be implemented as a retrofit without requiring important alterations, the effectiveness of the mechanism strictly relies on the direction of the gravity force and it is not effective if the lock is installed in a configuration (i.e. upside-down) in which the gravity drags the shorter driver pin element to touch the key pin.

Are also known the documents DE10353988A1, US2008271507A1, US2009205385A1, EP0452297A1, US2408283A, US2710536A that disclose solutions of “bumping” resistant lock however these solutions are expensive to make, and/or difficult to implement as a retrofit in a conventional pin/tumbler lock without requiring important alterations, and/or are not effective independently from the intensity of the bumping momentum and/or of its repetition frequency, and/or that are not effective independently for the configuration of installation of the lock.

Referring to the prior art, it is therefore not known a “bumping” resistant lock system that:
could be implemented even as a retrofit in a conventional pin/tumbler lock without requiring important alterations such as for example shape changes or dimension alterations of parts of the lock plug and/or hull;
could be implemented in a cheap and/or simple way such as for example the simple substitution of one of the existing conventional key pin/driver pin pairs with a new system that fits the housing of the existing pin pair;
the effectiveness of its resistance to “bumping” lock picking is in line of principle independent from the intensity of the “bumping” momentum and/or from the “bumping” pulse repetition frequency;
the effectiveness of its resistance to “bumping” lock picking is in line of principle independent from the installing configuration of the lock in particular with respect to the direction of the gravity force.

Furthermore, all prior art solutions are characterized by a strictly passive mechanism that obtains the resistance to the “bumping” by means of mechanical members that just keep a pre-existing shear plane engagement of the lock due to the fact that they cannot receive the “bumping” pulse, or they receive the pulse with a different momentum intensity and moves with a time delay with the respect to the other members that can engage the shear plane.

The prior art does not disclose any solution characterized by an active (and/or reactive) mechanism that obtains the resistance to the “bumping” by means of a mechanism that receives the “bumping” pulse and converts it into a reaction pulse suitable for driving the engagement of a member with the shear line of the lock, and/or for forcing the said member to keep a possible pre-existing engagement with the shear line of the lock.

### SCOPE OF THE INVENTION

The main scope of the present invention is that of achieving a “bumping” resistant lock apparatus characterized by an active (and/or reactive) resistance to the “bumping” through a mechanism that receives the “bumping” pulse and converts it into a reaction pulse suitable for driving the engagement of a member with the shear line of the lock, and/or for forcing the said member to keep a possible pre-existing engagement with the shear line of the lock.

Secondary (I) scope of the present invention is that of achieving a “bumping” resistance apparatus that could be implemented even as a retrofit in a conventional (and possibly pre-existing) pin/tumbler lock without requiring important alterations such as for example shape changes or dimension alterations of parts of the lock plug and/or hull of the lock.

A further (II) secondary scope of the present invention is that of achieving a “bumping” resistance apparatus that could be implemented in a cheap and/or simple way such as for example the simple substitution of at least part of at least one of the (eventually pre-existing) conventional key pin/driver pin pairs with a new component and/or mechanism that fits the housing of the pre-existing key pin/driver pin pair.

A further secondary (Ill) scope of the present invention is that of achieving a “bumping” resistance apparatus the effectiveness of which is in line of principle independent from the intensity of the “bumping” momentum and/or from the “bumping” pulse repetition frequency.

A further (IV) secondary scope of the present invention is that of achieving a “bumping” resistance apparatus the effectiveness of which picking is in line of principle independent from the installing configuration of the lock in general, and in particular from the installing configuration with respect to the direction of the gravity force.

A further (V) secondary scope of the present invention is that of achieving a “bumping” resistance apparatus characterized by a superior long-term reliability.

### DISCLOSURE OF THE INVENTION

In a first broad independent aspect the present invention achieves a “bumping” resistant pin/tumbler lock apparatus characterized by a reactive resistance to the “bumping” lock picking technique by means of a mechanism that receives at least part of the “bumping” pulse and converts it into a reaction pulse having direction of application opposite with respect to the received pulse so that to drive the engagement of at least one bumping lockout member with the shear line of the lock, and/or to force the said member to keep a possible pre-existing engagement with the shear line of the lock. This can be, for example (possibly but not exclusively), obtained by means of a reaction mechanism comprising:
at least one first longer driver pin that receives the “bumping” pulse from the side of the key cut;
at least one pivoting element that receives the “bumping” pulse from the driver pin;
at least one lockout member that receives the pulse from the pivoting element according to a configuration in which the direction of the received pulse is opposite with respect to the direction of the original “bumping” pulse.

In a first subsidiary aspect the present invention provides a reactive “bumping” resistance mechanism that can be implemented even as a retrofit in a conventional (and possibly pre-existing) pin/tumbler lock without requiring important alterations, for example by means of a mechanism having dimensions compatible to that of a conventional driver pin and that can be substituted to such driver pin by simply opening the pin housing hole, extracting the driver pin, dropping in the mechanism and finally closing the pin hole.

In a second subsidiary aspect the present invention provides a “bumping” resistance solution that works independently from the repetition rate of the “bumping pulses and that keeps or even increases its own effectiveness when the intensity of the “bumping” momentum is increased.

In a third subsidiary aspect the present invention can provide a “bumping” resistance solution that works independently from the installing configuration of the lock in particular with respect to the direction of the gravity force, by designing the reaction mechanism so that, even in the case that the lockout member should have brought in touch to the key pin so that to also receive part of the “bumping” pulse, such partial “bumping” pulse would have lower (or equal) intensity with respect to the reaction pulse transmitted to the lockout member by the reaction mechanism. This can be, for example (possibly but not exclusively), obtained by means of a reaction mechanism comprising:
at least one first longer driver pin that receives the “bumping” pulse from the side of the key cut;
at least one pivoting element that receives the “bumping” pulse from the driver pin with a first eccentricity e₁ and converts it into a secondary pulse;
at least one lockout member that receives the secondary pulse from the pivoting element with a second eccentricity e₂≦e₁ and according to a configuration in which the direction of the received pulse is opposite with respect to the direction of the original “bumping” pulse.

### BRIEF DESCRIPTION OF DRAWINGS

A full and enabling disclosure of the present invention, including the best mode thereof, directed to one of ordinary skill in the art, is set forth in the specifications, which makes reference to the appended figures, in which:

The FIG. 1 schematically illustrates the application of the “bumping” lock picking technique to a conventional pin/tumbler cylinder lock.

The FIG. 2 and FIG. 3 schematically illustrates some relevant prior art related to “bumping” resistance locks.

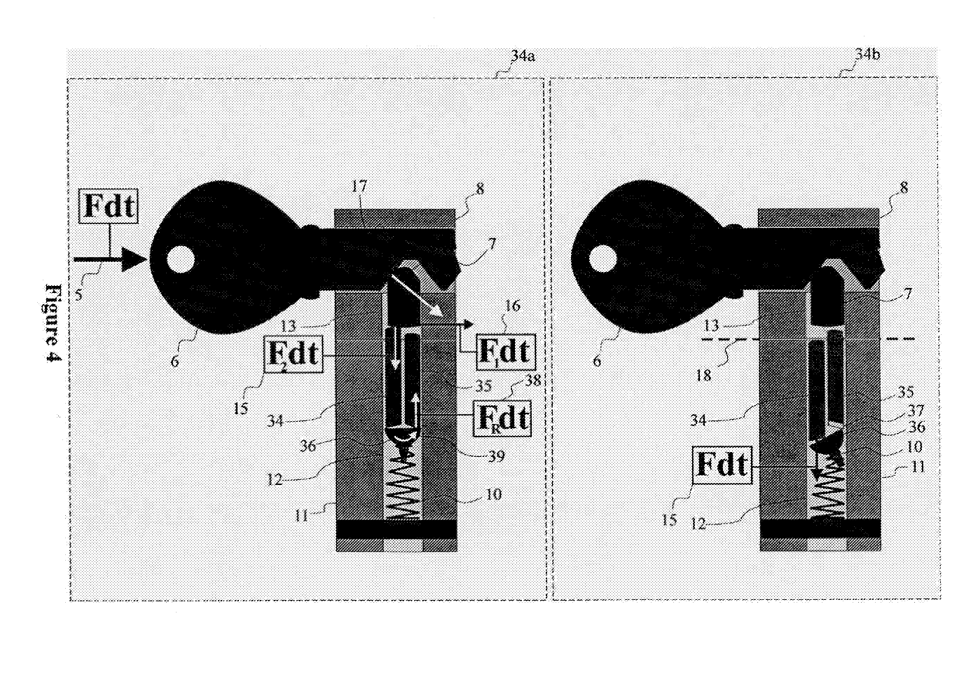

The FIG. 4 discloses a partial schematic representation, non-limiting, of an embodiment of an apparatus according to the present invention in which the frame (34a) is shown a partial section of the lock in which the functionality of the driver pin (counter-piston) is obtained by the cooperation of a first section of driver pin (34) characterized by a length that so that the section is compressed between the key pin (piston, 7) and the spring (10) indirectly through at least one pivoting element (36), and of a second section of driver pin (35) characterized by a length smaller with respect to that of the first section (34) and so that to, when the second section (35) leans on the pivoting element (36), the opposite end of the same second section (35) engages the shear line between the plug (8) and the hull (11) of the lock without having any contact point with the key pin (7).

The frame (34a) also illustrates how the momentum Fdt (5) applied to the key head (6) in order to pick the lock according to the “bumping” technique is vectorially decomposed in a first axial component F1dt parallel to the axis of the lock plug (rotor) and in a second radial component F2dt aligned along the axis of the pair key pin/driver pin (piston/counter-piston, 7, 9). While the axial component F1dt is ends on the lock plug (rotor, 8), the radial component F2dt is transmitted only to the driver pin section (34) that is in touch with the key pin (7). The frame (34b) of FIG. 4 illustrates the configuration achieved by the apparatus according to the present invention following the application of the lock picking momentum Fdt (5), in which the driver pin section (34) reaches a configuration displaced inside the hull (11) of the lock and transmits an eccentric momentum to the pivoting element (36) that causes a rotation and translation of the same element so that its protruding guiding end that is (normally) housed inside the spring (10) engages due to friction the surface of the hole (12) that houses the pair key pin/driver pin stopping the translation of the pivoting element (36) in the hole and locking out the possibility of (further) translation of the same in a configuration in which the second section of the driver pin (37) cannot displace itself inside the hull (11) trespassing a limit position of maximum insertion (37) that engages the shear line (18) between the plug (8) and hull (11) of the lock, thus preventing the rotation of the plug (8).

In addition, at least in the initial phase of the rotation and translation of the pivoting element (36) during which it is also in contact with the second section of the driver pin (35), the mechanism that comprises the same pivoting element (36) is capable to convert part of the momentum F2dt (15) received from the first driver pin section (34) in a momentum having direction opposite to that of the received one and that is transmitted to the second driver pin section (35) driving this said second section to engage with increased efficiency the shear line (18) between the plug (8) and the hull (11) of the lock.

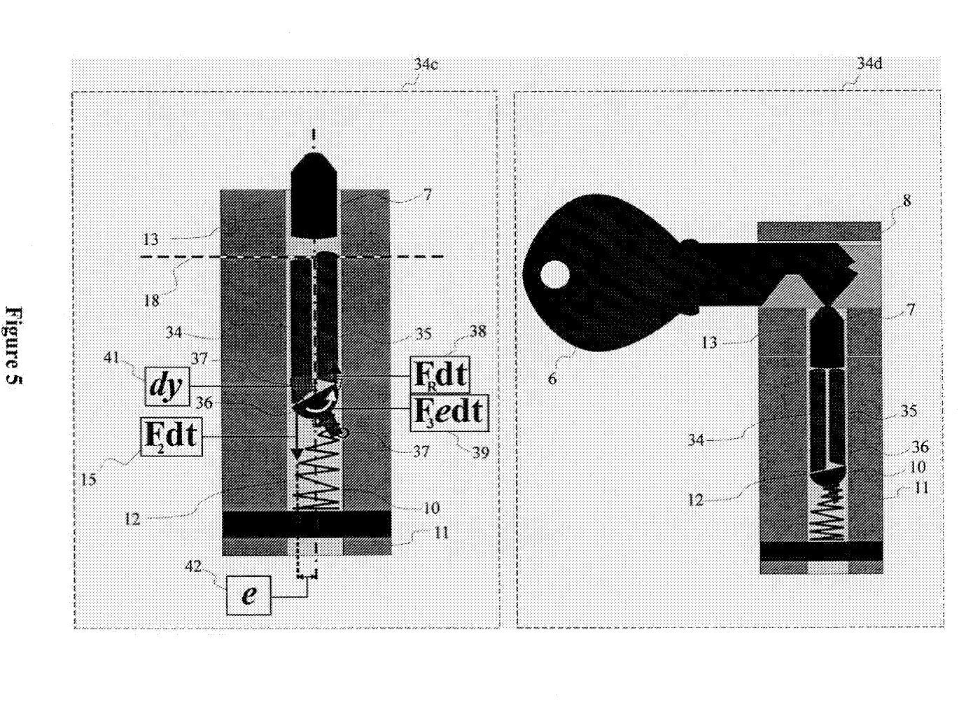

The FIG. 5 schematically illustrates the detail of some operating configurations achieved by the apparatus described as from the FIG. 4.

In particular the frame (34c) illustrates the detail of a partial schematic section of the apparatus shown in the time instant immediately following the application of the “bumping” momentum. As illustrated in the frame (34c) the component F2dt (15) received by the first driver pin section (34) is transmitted to the pivoting element (36) along a direction characterized by a first eccentricity e (42) with respect to the axis of the hole (12) that houses the driver pin(s). The momentum transmitted to the pivoting element (36) partially works against the spring (10) producing a small axial displacement dy (41), while the greater part, due to the eccentricity e (42), applies a rotational momentum F3edt (39) to the pivoting element (36) forcing it to rotate and transmit to the second driver pin section (35) a reaction momentum F4dt (38) with orientation opposite to that of the momentum F2dt (15) initially received from the first driver pin section (34).

According to what has been described in the above the mechanism comprising at least the driver pin sections (34, 35) and the pivoting element (36) produces a reaction to the “bumping” momentum (5) that is not only passive that results in driving at least one lockout member [in particular the second driver pin section (35) in the illustrated embodiment] towards a configuration that increases the engagement between the plug (8) and hull (11) of the lock.

The pivoting element (36) can be characterized in addition, even if not limiting, by at least one protruding end, or by another type of guiding, lockout and/or stroke-limiting element, having the function of guiding the position of the pivoting element (36) possibly coupling with the end, eventually tapered, of a spring (10).

The said protruding end, or guiding, lockout and/or stroke-limiting element, if present, may also and/or alternatively have the function of offering a stroke limit point for the displacement of the pivoting element (36) also possibly with the scope of increasing the resistance to the lock picking of the apparatus, for example in case of a particularly strong “bumping” pulse causing a rotation and translation of the pivoting element (36) that brings the said element in a configuration where the protruding end jams (37) against the wall of the hole (12) that houses the mechanism, and the said jamming prevents the possibility of further translation of the pivoting element (36) along the axis of the hole (12) with respect to the same jammed position.

The frame (34d) of FIG. 5 furthermore illustrates a partial schematic section of a configuration of the apparatus that is reached during the stoke of insertion of the key (6) in the lock, in the said configuration the key pin (7) is pushed deep in the pin housing hole (12, 13) until it reaches the position of maximum insertion. In such configuration the action of the key pin is slowly transmitted to the pivoting element (36) through the simultaneous action of both sections of driver pin (34, 35), and for this reason the rotation of the same pivoting element (36) cannot reach the jamming configuration.

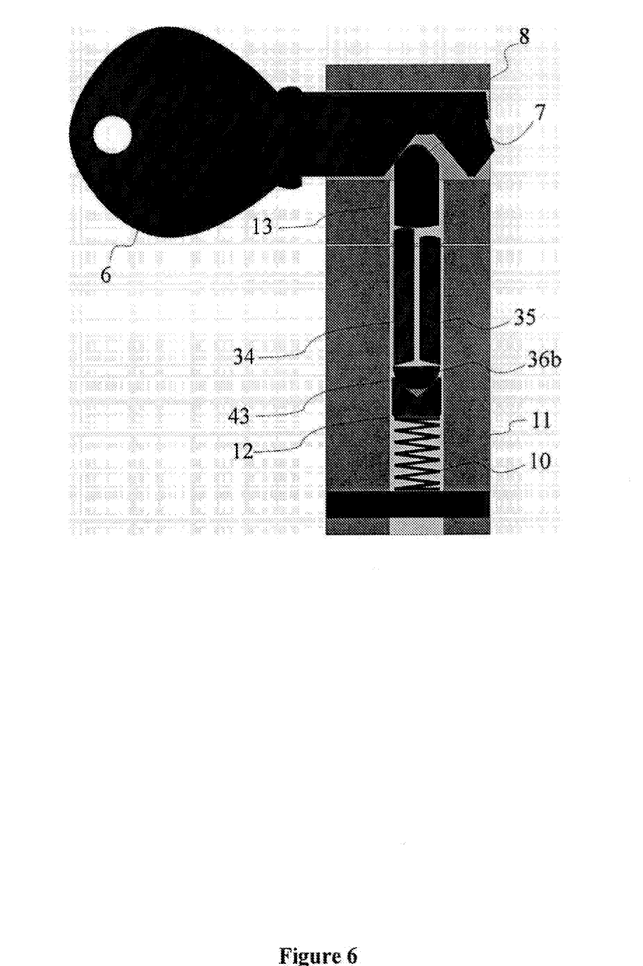

The FIG. 6 discloses a schematic representation, non-limiting, of a further embodiment of the apparatus according to the present invention. In particular, the embodiment illustrated in FIG. 6 is characterized by an at least partially spherical shape of the pivoting element (36b) that is at least partially coupled to a semispheric and/or conic cavity in a sliding element (43) that is contrasted by the spring (10).

In this configuration the pivoting element (36b) could also comprise a stroke limiting system for the rotation and/or translation (not illustrated).

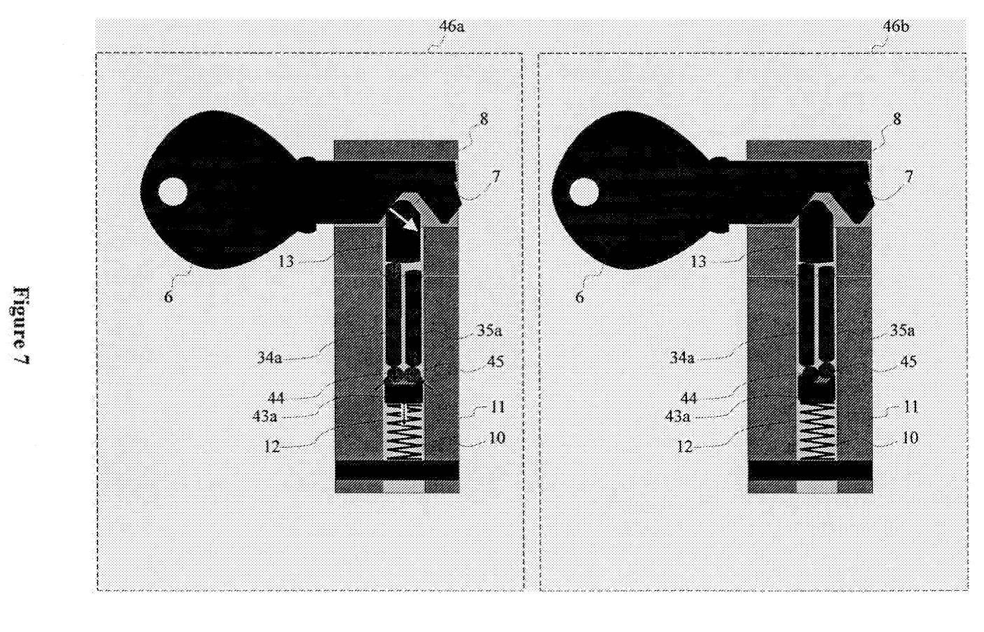

The FIG. 7 discloses a schematic representation, non-limiting, of a further embodiment of the apparatus according to the present invention. In particular, the embodiment illustrated in the frame (46a) of FIG. 7 is characterized by a reaction mechanism in which the component of the “bumping” lock picking momentum that is received by the first driver pin section (34a) is transmitted to one or more balls (44, 45) that are compelled, due to the reaction forces of their housing element (43a), to convert at least part of the picking momentum into a reaction momentum that drives the second driver pin section (35a) to engage (or to deepen a pre-existing engagement of) the shear line between the plug (8) and the hull (11) of the lock. The frame (46b) of FIG. 7 illustrates how the shape of the housing (43a) that houses and confines the balls (44, 45) also works as a stroke limiting element for the stopping the movement of the balls in a configuration that does not allow to the second driver pin section (35a) to get in contact with the key pin (7) at least in resting conditions.

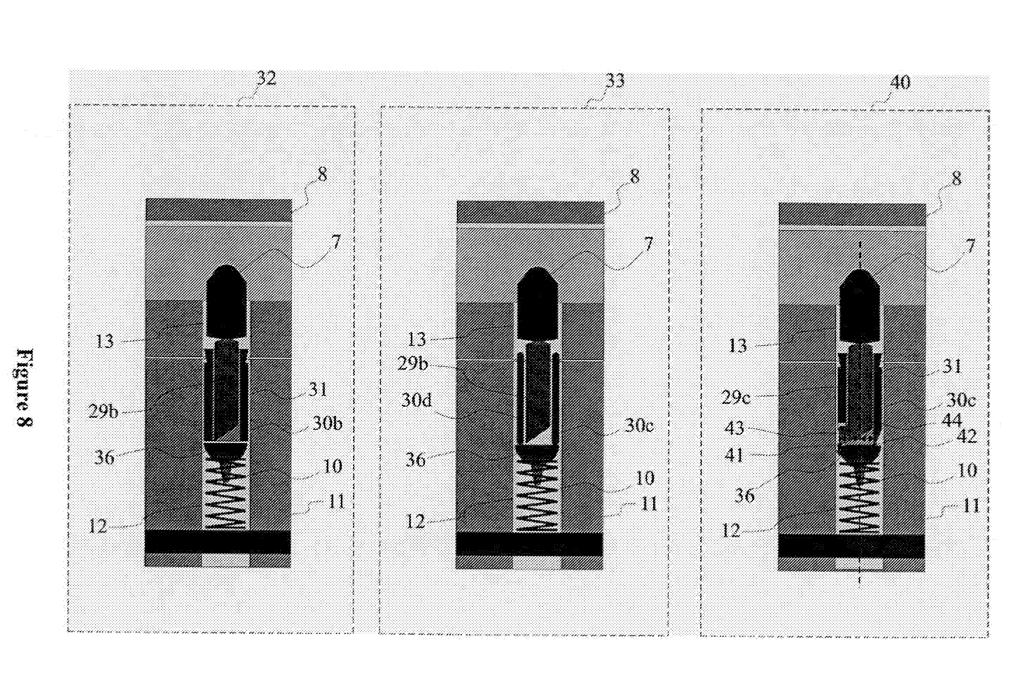

The FIG. 8 discloses a schematic representation, non-limiting, of a further embodiment of the apparatus according to the present invention. In particular the frame (32) of FIG. 8 illustrates a further alternative embodiment (not limiting) in which at least one first driver pin section (29b) is housed inside an at least partial cavity or groove of at least one second driver pin element (31) having a length so that it engages the shear line between the plug (8) and the hull (11) of the lock but without touching the key pin (7). The first driver pin section (29b), on the side opposite to that in touch with the key pin (7) could be for example shaped so that to transmit the “bumping” action as a non-baricentric momentum to at least one pivoting element (36) that is capable to create a reaction momentum on the second driver pin section (30b) in an orientation opposite to that of the momentum received by the first driver pin section (29b). The second driver pin section (30b) could be also possibly shaped or characterized by elements capable to maximize the engagement friction against the wall of its housing hole, such as for example (not limiting) a dove-tail profile, consequently to the action of a rotational momentum that is applied to the plug (8) of the lock in its locked configuration, that is a condition necessary to attempt the lock picking according to the technique of “bumping”.

The second driver pin section (30b) could be also possibly (not limiting) characterized by a shape or elements capable of minimizing the sliding friction with the first driver pin section (29b) in the portion where the first driver pin section (29b) is housed inside the second driver pin section (30b).

The frame (33) of FIG. 8 illustrates a further alternative embodiment (not limiting) derived from that already described in the frame (32) and in which the functionalities of the second driver pin section are obtained through a multiplicity of needle-shaped pins (30c) that are characterized by a length so that at least one of them, in resting conditions, engages the shear line between the plug (8) and the hull (11) of the lock but does not touch the key pin element (7).

The frame (40) of FIG. 8 illustrates a further alternative embodiment (not limiting) derived from that already described in the frame (32) and that is characterized by the fact that the first driver pin section (29c) touches the pivoting element (36) in a point (41) having a first eccentricity e1 (43) and it at least housed in a second driver pin section (30c) that is shaped so that it touches the pivoting element (36) in a point (42) having a first eccentricity e2 (44) not bigger than the first eccentricity e1 (43).

It is also made clear that modifications and variations can be made to the described device without leaving the scope of protection of the present invention.

1. An apparatus that can be implemented in a lock device with the purpose to make the lock resistant to the manipulation through the method of “bumping”, and is possibly also implementable in an existing lock (“retrofitting”) without modification of the pre-existing body and/or rotor of the same lock, comprising:
a) at least one engagement element capable to displace itself in at least one position of engagement that can prevent the opening of the lock, as well as to displace itself at least in one position of disengagement that can allow the opening of the lock; and
b) at least one reaction mechanism capable to drive and/or to further push the engagement element in a position of engagement under the effect of the mechanical pulse that characterizes an attempt of manipulation through the method of “bumping”; and
c) at least one operation mechanism, not necessarily distinct, even only partially, from the reaction mechanism, capable to drive the displacement of the engagement element in a position of disengagement through a movement that is operated by the non-pulsed action of the insertion of a key.

2. The apparatus according to the claim 1 wherein at least one engagement element comprises at least one counter-piston or section of counter-piston wherein the inability to receive any component of the “bumping” manipulation mechanical pulse along a direction capable to drive its disengagement.

3. The apparatus according to claim 1 wherein at least one engagement element is characterized by is a shape and/or a length that does not allow the same element to touch the piston when the lock is under resting conditions in closed state.

4. The apparatus according to claim 1 wherein at least one engagement element is a shape and/or a length that causes the element to engage between the rotor and the body of the lock when the same lock is under resting conditions in closed state.

5. The apparatus according to claim 1 in which the reaction mechanism comprises at least one transmission element, that is characterized by the ability to accept, at least partly, the component of the “bumping” mechanical pulse conducted by a piston along the direction of motion of the same piston.

6. The apparatus according to claim 1 in which at least one transmission element comprises at least one counter-piston or section of counter-piston, possibly also having engagement functions between the body and the rotor, that is characterized by a length greater than that of the engagement element and/or by a shape so that to bring the same transmission element in contact with the piston when the lock is under resting conditions in closed state.

7. The apparatus according to claim 1 in which the reaction mechanism comprises one or more moving elements, possibly cooperating together and/or with other elements of the lock, in order to receive at least part of the “bumping” mechanical pulse transmitted by at least one transmission element, and have it converted, at least partly, into a reaction pulse that is applied to at least one engagement element according to a direction that drives its engagement and/or increase of its engagement between the body and the rotor.

8. The apparatus according to claim 1 in which the reaction mechanism allows at least one end-of-travel configuration of the kinematism induced by the “bumping” mechanical pulse where a jamming condition arises and momentarily blocks the possibility of further movement of at least one between the engagement elements and/or transmission elements.

9. The apparatus according to claim 1 in which the reaction mechanism comprises at least one pivoting element shaped and arranged so that to receive at least part of the “bumping” pulse along a direction eccentric with respect to its centre of rotation so that to obtain a mechanical torque that drives the pivoting element to apply, directly or not, a reaction pulse to at least one engagement element according to a direction that pushes the latter to engage and/or increase the engagement between the body and the rotor.

10. The apparatus according to claim 1, wherein the non-pulsed action that is driven by the insertion of a key is transmitted to the reaction mechanism through a configuration and/or combination of engagement and/or transmission elements that is different from that induced by a “bumping” mechanical pulse, (i.e. through a smaller eccentricity of the overall action on the pivoting element and suitable to limit the configuration of the mechanism (i.e. the rotation of the pivoting element to a condition that prevents the reaching of the end-of-travel jamming and/or allows the dislocation of the engagement elements, and possibly of other elements having engagement functions, in a position of disengagement between the body and the rotor.
